(19) United States
(12) Patent Application Publication
(10) Pub. No.: US 2025/0328659 A1
(43) Pub. Date: Oct. 23, 2025

(54) SOURCE DETECTION USING UNIQUE TRACEABLE IMAGES WITHIN WEBPAGES

(71) Applicant: EchoMark, Inc., Kirkland, WA (US)

(72) Inventor: Clayton HUTHWAITE, Chesterfield, VA (US)

(21) Appl. No.: 18/643,737

(22) Filed: Apr. 23, 2024

(51) Int. Cl. G06F 21/60; G06F 40/143; G06V 30/10; G06V 30/416

(52) U.S. Cl. CPC G06F 21/604; G06F 40/143; G06V 30/10; G06V 30/416

(57) ABSTRACT

Data leaks can be deterred and detected by generating webpages that include traceable elements that are unique to those accessing the webpages. If a leak of information is found in an artifact of a webpage, the unique elements can be used to trace the artifact to the source, thereby identifying the entity that accessed the webpage of the artifact. To do so, unique optical elements are generated for access entities. The unique optical elements can include encoded or nonencoded optical elements. If an artifact includes an encoded optical element, the encoded data is extracted and used to identify the source. Where the artifact includes a nonencoded optical element, the nonencoded optical element can be compared to those corresponding to other access entities to identify which entity accessed the website from which the artifact was derived.

### BACKGROUND

Data leaks in companies often happen when someone deliberately shares sensitive information without permission. These leaks can cause loss of money and trust. Source identification measures deter data leaks and play a crucial role in identifying those responsible if a breach occurs. Protecting and deterring against leaks of sensitive and confidential information can help safeguard against financial loss and reputational damage.

### SUMMARY

At a high level, aspects herein relate to source detection for information leaks. In particular, traceable optical elements can be rendered as part of a webpage. These optical elements are unique and generated for those entities that may access the webpage. When an access entity accesses the webpage, the corresponding unique optical element for that entity is rendered on the webpage. In this way, if information on the webpage is copied by photo, snip, or another mechanism, the resulting copy (which may also be called an artifact), can be used to identify the particular access entity, thus providing a starting point for any information source investigation.

To achieve this, unique optical elements may be generated for access entities that have access to a webpage. Each unique optical element is visually distinct so that each access entity has a different unique optical element. Unique optical elements can include encoded optical elements, such as bar codes that represent information in a machine-readable format or may be nonencoded optical elements that are visually distinct but may not encode or store machine-extractable data in a standardized manner. The unique optical elements can be stored where it can be retrieved using a resource identifier, such as a URI (uniform resource identifier) or local memory address.

When an access entity attempts to access a webpage having information, the access entity is identified. In some case, the webpage being accessed will be rendered using code included in a markup language. To cause the webpage to render with the access entity's unique optical element, the markup language for the webpage can be modified to include the unique optical element's resource identifier. Various modifications to the markup language may be made so that the unique optical element does not affect the content of the webpage, such as causing it to render in the background and reducing its opacity so that it is less than the opacity of the content.

To help with detection, the unique optical element may be rendered in a repeating pattern. In cases where the unique optical element is rendered in the background with superimposed content, the repeating pattern increases overall area occupied by copies of the unique optical elements. This helps during detection because an artifact will have a higher likelihood of including an entire element or a substantial portion of an element or elements on which to perform the detection.

When an artifact of a webpage is recovered, any unique optical elements captured by the artifact can be used to help identify the source. Where the unique optical element is an encoded optical element, the data it encodes may be read by a machine and used to identify its corresponding access entity. If the unique optical element includes a nonencoded optical element, the nonencoded optical element of the artifact can be compared to other nonencoded optical elements in a source index to identify a matching nonencoded optical element and its corresponding access entity.

This summary is intended to introduce a selection of concepts in a simplified form that is further described in the detailed description section of this disclosure. The summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an aspect operating environment in which aspects of the technology can be employed, in accordance with an aspect described herein;

FIG. 2 illustrates an example in which encoded optical elements are generated, in accordance with an aspect described herein;

FIG. 3 illustrates an example in which nonencoded optical elements are generated, in accordance with an aspect described herein;

FIG. 4 illustrates an example in which markup language for generating a webpage is modified, in accordance with an aspect described herein;

FIG. 5A illustrates an example client device displaying a browser having a webpage, in accordance with an aspect described herein;

FIG. 5B illustrates an example in which the webpage is rendered having a unique optical element in a repeating pattern, in accordance with an aspect described herein;

FIG. 5C illustrates another example in which the webpage is rendered having a unique optical element in a repeating pattern, in accordance with an aspect described herein;

FIG. 6A illustrates an example in which a unique optical element is extracted from a webpage, in accordance with an aspect described herein;

FIG. 6B illustrates an example in which an access entity is identified from the extracted unique optical element, in accordance with an aspect described herein;

FIG. 7 illustrates another example in which an access entity is identified from a unique optical element, in accordance with an aspect described herein;

FIG. 8 illustrates a flow diagram of an example method for rendering a webpage with a unique optical element, in accordance with an aspect described herein;

FIG. 9 illustrates a flow diagram of an example method for identifying an access entity from an artifact of a webpage, in accordance with an aspect described herein; and

FIG. 10 is an example computing device suitable for implementing aspects of the technology, in accordance with an aspect described herein.

### DETAILED DESCRIPTION

Information source detection can help companies deter malicious leaks of confidential information, in addition to identifying the potential source of a leak if one does occur. It enables the attribution of responsibility, which is essential for legal actions and enforcing accountability.

To safeguard confidential information, companies employ various document source detection methods. One common strategy involves embedding invisible watermarks in images, which remain hidden to the naked eye but can be revealed through specific image modification techniques. While effective in some scenarios, this approach may fail with certain replication methods, such as screenshots or photographs, where the watermark may fail to appear.

Digital Rights Management (DRM) is another tool aimed at preventing leaks by finely controlling how digital content is accessed, viewed, and distributed. Despite its advanced capabilities, DRM is not foolproof; it can be circumvented with specialized software, complicating legitimate access and potentially driving users towards seeking DRM-free alternatives. Additionally, while DRM can sometimes indicate the security clearance needed to access leaked data, pinpointing a specific individual among many with the same access level remains a challenge.

Other existing document source detection methods use steganographic solutions. Steganography involves hiding a secret message within an image in such a way that the presence of the message is undetectable. While steganography can be effective for covert communication, like invisible watermarks, steganographically hidden messages can be lost through cropping, compression, or format conversion.

To improve upon these existing method, aspects of the technology described herein cause webpages to render with an optical element that is unique to an individual or device. When an entity goes to access the webpage, the optical element unique to that access entity can be rendered as a low-opacity repeating pattern within the background of the webpage. If the webpage is copied, photographed, snipped, or the like, the visually traceable unique optical element is transferred to the copy. When an artifact of the webpage, such as the copy, is discovered, the unique optical element can be used to identify the access entity, which can assist with a leak investigation.

In an example of the technology, unique optical elements are generated for access entities. Each of the unique optical elements can be generated so that it is distinct from the other unique optical elements and, therefore, be used to identify one of the access entities. Unique optical elements can be encoded optical elements, such as a bar code that encodes information that can be used to identify the access entity. In another aspect, the unique optical elements are nonencoded optical elements that include images with distinct features not tied to a particular encoding scheme.

When one of the access entities attempts to access a webpage, its corresponding unique optical element is identified. The webpage is then rendered with the access entity's unique optical element. This may be done by modifying the markup language used to generate the website and including a resource identifier for the access entity's unique optical element.

The unique optical element can be rendered on the webpage as a background image. In another aspect, the image of the unique optical element is superimposed over content of the webpage, such as text or images. The opacity of the unique optical element can be reduced to less than the opacity of the content, helping to keep the content clear and unobscured. The webpage may also be rendered with a repeating pattern of the unique optical element, where copies of the unique optical element are repeated across the webpage. This becomes helpful if only a portion of the webpage is leaked, and also helps to ensure the unique optical element or substantial portion is therefore visible and distinguished from the content of the webpage.

If there is a leak, and an artifact such as a photo or copy of the webpage is found, the unique optical element in the webpage can be used to identify the access entity. Where the unique optical element is an encoded optical element, a reader can be used to decode the information, which is then used to identify the access entity that accessed the webpage. Where the unique optical element is a nonencoded optical element, the nonencoded optical element of the artifact can be compared to nonencoded optical elements generated for the access entities to determine a match that identifies the access entity that accessed the webpage. In aspects, content may be extracted from an artifact using an OCR (optical character recognition) model or image recognition model to isolate a unique optical element, or portion thereof, for identifying the access entity.

This technology provides advancements and advantages over existing methods. Aspects of the technology render a visible optical element that has a better chance of being included in a photograph, copy, print, or snip of the webpage. Moreover, some of the techniques can render the same webpage differently for different access entities in the sense that each includes their respective unique optical element within the webpage. This is advantageous over existing watermarking techniques that mark with invisible markings or do not create webpages that are unique to the individual visiting the webpage.

Further, since the technology may create a unique and traceable optical element for entities, the webpage itself is marked, helping to identify individuals that may copy the webpage. Some existing DRM solutions manage webpage access, but once accessed, copies of those webpages may not be directly traceable to a specific source, but may rather trace the copies to an existing group having common access permissions. As such, the technology may be used in conjunction with existing DRM solutions to help specifically pinpoint access entities when the DRM solution is not be able to.

Moreover, the technology is an advancement beyond known steganographic methods as well, since some of these methods lose all or portions of an embedded message when only a portion of the source is copied or other formatting measures are applied to the source. In particular, the technology may use small changes between optical elements that make them distinct in order to identify corresponding access entities. Further still, unique optical elements can be rendered as part of a repeating pattern across a webpage, helping to identify the access entity regardless of the webpage section that is copied. This allows access entity identification when even the unique optical element is relatively small or from just a portion of it. As such, the present technology may be able to identify access entities from relatively smaller artifacts compared to existing steganographic methods.

It will be realized that the methods previously described are only examples that can be practiced from the description that follows, and the examples are provided to more easily understand the technology and recognize its benefits. Additional examples are described with reference to the figures.

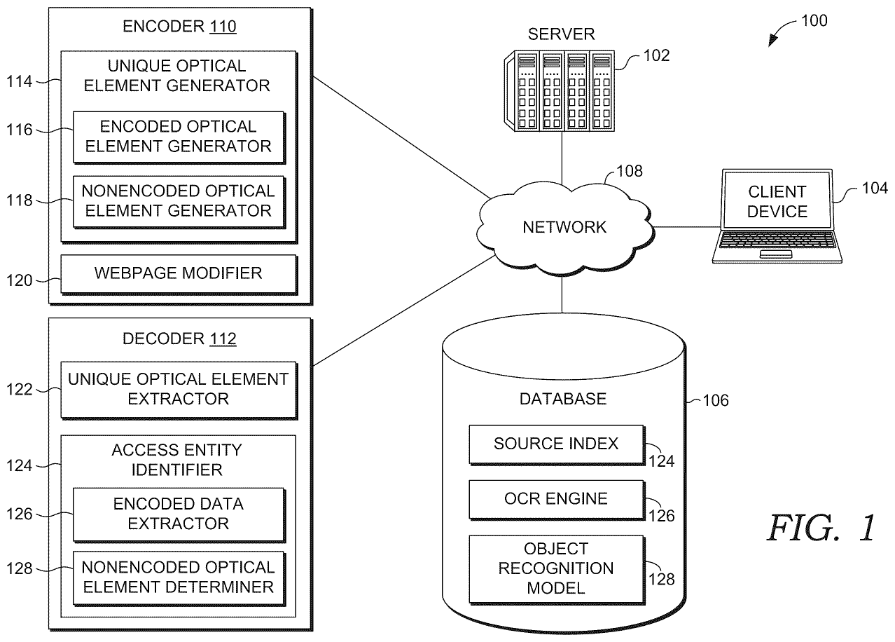

With reference first to FIG. 1, an example operating environment 100 in which aspects of the technology may be employed is provided. Among other components or engines not shown, operating environment 100 comprises server 102, client device 104, and database 106, which communicate via network 108.

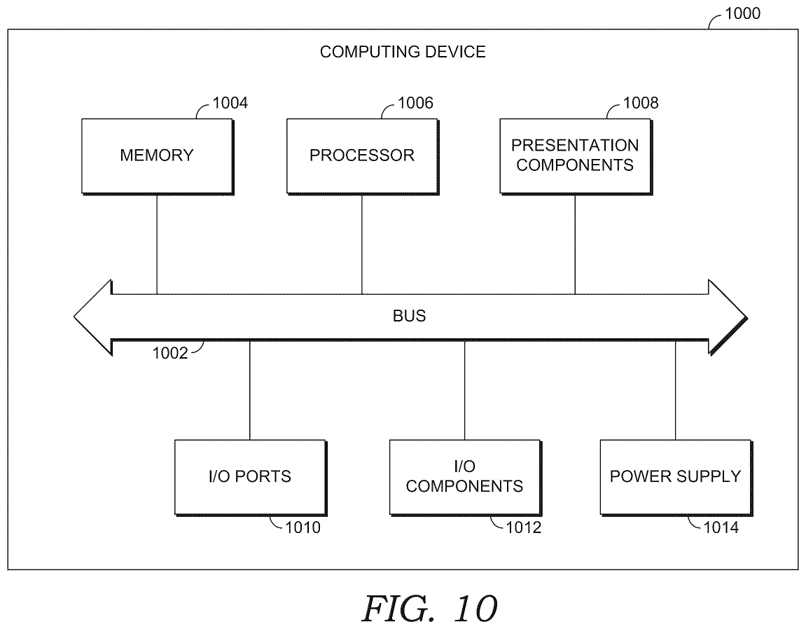

Generally, server 102 is a computing device that implements functional aspects of operating environment 100, such as one or more functions of encoder 110 and decoder 112 for rendering a webpage with a unique optical element for later identifying an entity that has accessed the webpage. One suitable example of a computing device that can be employed as server 102 is described as computing device 1000 with respect to FIG. 10.

Client device 104 is generally a computing device, such as computing device 1000 of FIG. 10. Client device 104 may be used to access and display webpages having unique optical elements for an access entity. In aspects, client device 104 may perform functions described with respect to encoder 110 and decoder 112. Client device 104 and server 102 may perform any combination of functions when implementing aspects of the technology, such as rendering webpages and identifying access entities from an artifact of a webpage.

Components of operating environment 100 may be generally used to render webpages that include unique optical elements specific and traceable to the entity that accessed the webpage. Thus, if information from the webpage is leaked, a recovered artifact of the webpage that includes the unique optical element can be used to identify the access entity of the webpage, which is a potential source of the leaked information.

Encoder 110 can be generally used to cause webpages to render with unique optical elements that can identify the access entity of the webpage. In the example shown, encoder 110 comprises unique optical element generator 114, which includes encoded optical element generator 116, nonencoded optical element generator 118, and webpage modifier 120 for causing webpages to render with unique optical elements corresponding to the entities accessing the webpages.

As used throughout, an access entity generally refers to any identifiable entity, whether it be an individual user (including a user account), a machine, or any other traceable source, that has the capability to access a webpage.

A webpage includes a digital document or resource rendered to include various types of content, such as text, images, and multimedia elements, which are accessible over a network. Webpages may be accessible through web browsers or other applications and may include the Internet, or an intranet or extranet network, or other network. Webpages may be accessed by access entities using client device 104.

Access entities may be identified prior to accessing a webpage or at the time the webpage. Identifying information for the access entities may be stored in source index 130, for instance. Encoder 110 may generate a unique optical element for each identified access entity using unique optical element generator 114.

A unique optical element is generally a visual element that is distinguishable and distinct, and can be rendered on a computer display, including being rendered as part of a webpage. Each unique optical element may be distinguishable from other unique optical elements based on its visual features. In aspects, a generated unique optical element (or the data used to generate the optical element) may be stored in source index 130 with its corresponding access entity.

Unique optical elements comprise encoded optical elements and nonencoded optical elements. An encoded optical element is generally a type of unique optical element having a visual representation of contrasting elements arranged according to an encoding scheme. Two- and three-dimensional bar codes are examples of encoded optical elements. Some specific examples include QR (quick response) codes, Aztec codes, PDF 417 codes, Code 39 codes, Code 128 codes, and the like. Other encoding schemed for encoding data into visual elements from which the data can be extracted by a trained reader may be developed and used. A nonencoded optical element is generally a type of unique optical element that has distinctive visual features, such as shape, color, texture, or composition, that enable it to be recognized and differentiated from others. Visual features of nonencoded optical elements can be rendered without the use of an underlying encoding scheme to embed data or information within the features themselves. Encoded optical elements and nonencoded optical elements may be generated and stored in various file formats, such as PNG (portable network graphic), JPEG (joint photographic experts group), SVG (scalable vector graphics), GIF (graphics interchange format), TIFF (tagged image file format), BMP (bitmap image file) or other like formats, which can be used by webpage modifier 120, as will be described, to render as a visual element within a webpage at display.

In general, encoder 110 may cause webpages to render with any one or more unique optical elements, including an encoded optical element, nonencoded optical element, or combinations thereof. As will be further described, any of these unique optical elements can be used to identify an access entity that accessed the webpage using decoder 112.

To generate an encoded optical element for rendering on a webpage, encoder 110 may employ encoded optical element generator 116. At a high level, the encoded data may include any data that identifies an access entity. For example, encoded optical element generator 116 may encode a name of an individual or a machine identifier within the encoded optical element. In aspects, a unique string of characters or numbers may be generated for and mapped to the access entity identification. Each unique string may be different so as to distinguish the access entities. Unique strings may include any set of characters or numbers, and may comprise identifying information for respective access entities. The mapping may be stored in source index 130 and used to identify the access entity from the unique string via the mapping. In an aspect, a unique string can be a hash value representation of an access entity's identifying information. The unique string can be encoded into an encoded optical element using encoded optical element generator 116.

Encoded optical element generator 116 inputs the data to be encoded into an optical encoding algorithm. As an example, the optical encoding algorithm can have an encoding scheme for arranging the encoded data into a visual pattern (e.g., black and white squares or lines). The rules of the encoding scheme determine the placement of, for example, data segments, error correction codes, quiet zones, alignment patterns, or other structural elements within the optical code. Further adjustments may be made to enhance readability by an optical scanner, such as those that will be discussed. The output of encoded optical element generator 116 provides an encoded optical element having visual features that are encoded representations of the data inputs.

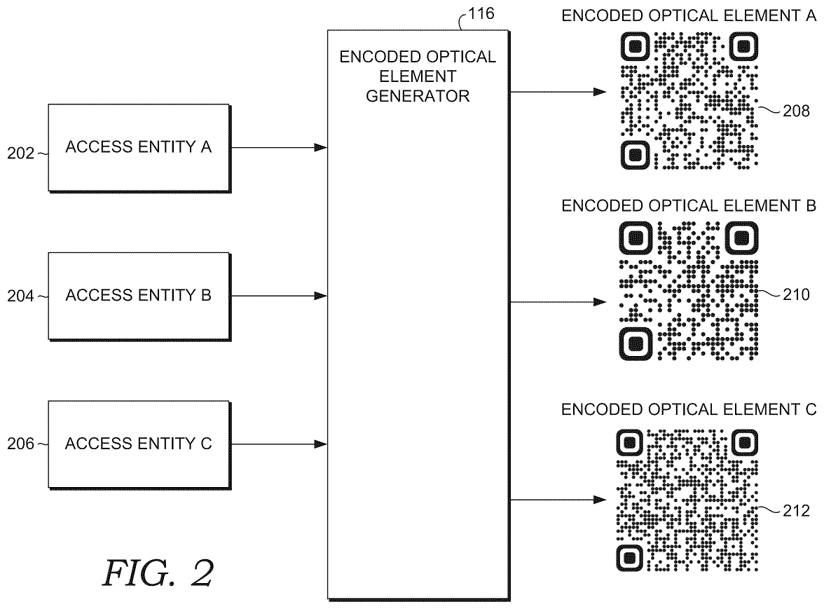

Turning briefly to FIG. 2, the figure illustrates an example in which encoded optical element generator 116 generates a plurality of encoded optical elements as unique optical elements for access entities. Here, access entity A 202, access entity B 204, and access entity C 206 represent access entities that may be identified. While only three are illustrated, there may be any number of identifiable access entities. For each access entity, encoded optical element generator 116 generates an encoded optical element that encodes some identifiable information. In the illustrated example, encoded optical element generator 116 has output encoded optical element A 208, encoded optical element B 210, and encoded optical element C 212. Encoded optical element A 208 encodes information that can be used to identify access entity A 202. Encoded optical element B 210 encodes information that can be used to identify access entity B 204. Likewise, encoded optical element C 212 encodes information that can be used to identify access entity C 206.

Returning to FIG. 1, as noted, some aspects of the technology generate nonencoded optical elements that can also be used to identify the access entities for which they were generated. Nonencoded optical element generator 118 may be used to generate a nonencoded optical element for each access entity, where each nonencoded optical element corresponds to an access entity and has distinct visual features that distinguish one nonencoded optical element from other nonencoded optical elements.

In an aspect of the technology, nonencoded optical element generator 118 uses a generative model to generate the nonencoded optical elements. For instance, a generative model may be trained to generate visual outputs representative of an input textual description. As an example, the input textual description could include instructions to generate a two-dimensional tile having a unique pattern of features. This is an example, and other prompts may be used to generate a visual element having distinct features that can be provided as the nonencoded optical element. Other models may be used or designed to generate distinct visual patterns that can be used as nonencoded optical elements.

Having generated the nonencoded optical elements, unique optical element generator 114 may store the nonencoded optical elements within source index 130. Each nonencoded optical element can be mapped to an access entity or other identifier or representation thereof, such that each of the nonencoded optical elements can be used to identify an access entity.

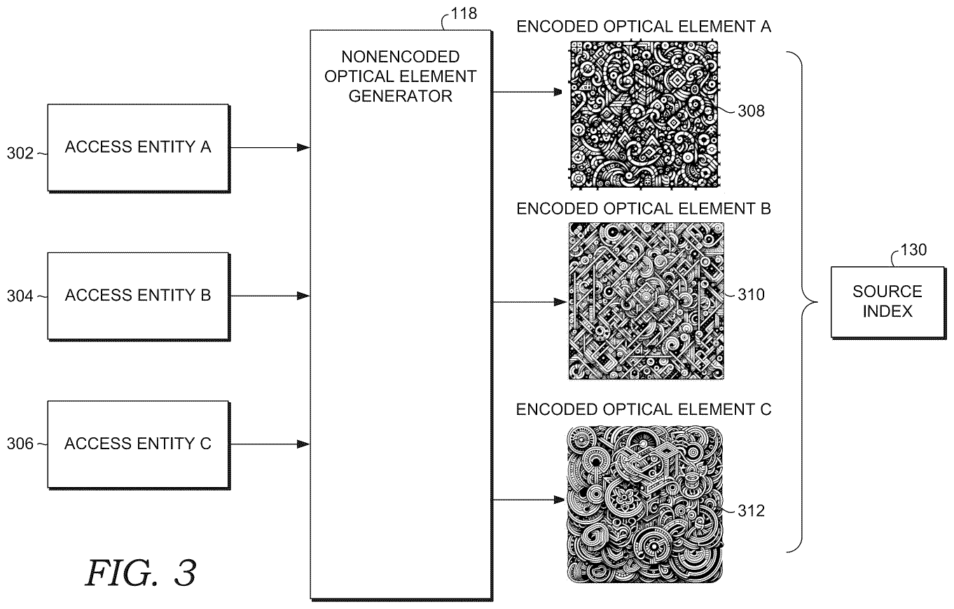

FIG. 3 illustrates an example in which nonencoded optical element generator 118 generates a plurality of nonencoded optical elements as unique optical elements for access entities. In this example, access entity A 302, access entity B 304, and access entity C 306 represent access entities that may be identified. Similarly, while only three are illustrated, there may be any number of identifiable access entities. For each access entity, nonencoded optical element generator 118 generates a nonencoded optical element that has features distinguishable from other nonencoded optical elements of other access entities.

In the example provided by FIG. 3, nonencoded optical element generator 118 outputs nonencoded optical element A 308, nonencoded optical element B 310, and nonencoded optical element C 312. In this example, each of nonencoded optical element A 308, nonencoded optical element B 310, and nonencoded optical element C 312 provide a two-dimensional tile that each have a different pattern. The features provided by nonencoded optical element A 308 are different from those of nonencoded optical element B 310 and nonencoded optical element C 312, and likewise for other nonencoded optical elements. As such, these features may be used to identify respective access entities, such as access entity A 302, access entity B 304, and access entity C 306 that respectively correspond to nonencoded optical element A 308, nonencoded optical element B 310, and nonencoded optical element C 312. The generated nonencoded optical elements, including nonencoded optical element A 308, nonencoded optical element B 310, and nonencoded optical element C 312 can be stored in source index 130 for use in identifying their respective access entities.

Turning back to FIG. 1, when an access entity attempts to access a webpage using client device 104, encoder 110 causes the webpage to render with the unique optical element generated by unique optical element generator 114 that corresponds to the particular access entity. Webpage modifier 120 may be used to cause the accessed webpage to render having the unique optical element corresponding to the access entity.

Webpage modifier 120 may determine that the access entity is attempting to access a webpage and identify the access entity based on a user account, user identifier, machine identifier, or other identifying characteristic for the access entity. An identifier may be initially provided or created for the access entities and stored in database 106. As an example, webpage modifier 120 may be executed by a machine within network 108 that is between client device 104 and a web server providing the webpage. In another aspect, webpage modifier 120 may be executed by client device 104. In another aspect, webpage modifier 120 may be executed by a machine hosting the web server. As with other components of FIG. 1, webpage modifier 120 may be hosted by various machines in various different arrangements.

Based on identifying the access entity, webpage modifier 120 may retrieve the unique optical element corresponding to the identified access entity. In an aspect, the unique optical element is retrieved from source index 130. In some aspects, the identified access entity might be previously unknown. If the access entity is unknown, or otherwise not identified, then a new unique optical element may be generated for the access entity using unique optical element generator 114, and may be stored in source index 130 using methods previously described.

Webpage modifier 120 may cause the webpage to render with the retrieved unique optical element. The rendered webpage may be displayed at client device 104. In aspects, webpage modifier 120 causes the webpage to render with one or more copies of the unique optical element. The unique optical element may be rendered as a repeating pattern on the webpage. In an aspect, the repeating pattern of the unique optical element is rendered as a background, where content (e.g., images or text) on the webpage are superimposed onto the background repeating pattern. In another aspect, the repeating pattern is superimposed over content of the webpage.

In aspects, having a repeating pattern of the unique optical element, the repeating pattern may comprise copies of the unique optical element rendered adjacent to one another. For instance, a first copy of the unique optical element may be adjacent to and not overlapping with a second copy of the unique optical element when rendered on the webpage. The repeating pattern may be rendered over all of, or substantially all of, the webpage or individual display area within the webpage.

Webpage modifier 120 may modify the opacity of a unique optical element when rendered. In aspects, the opacity of the unique optical element is less than the opacity of content provided on the webpage. In some display systems, an opacity of 100% indicates that an element is fully opaque and that objects behind the element cannot be seen through the element on display. As the opacity of the element is decreased, the visibility of an object behind the element increases. Reducing the opacity helps the unique optical element from obscuring content of the webpage and helps keep the unique optical element from distracting a reader. As an example, the opacity of the unique optical element may range from 10% to 90% in some implementations of the technology.

As noted, some webpages are rendered from reading a markup language. In such cases, webpage modifier 120 causes the webpage to render with the unique optical element by modifying the markup language of the webpage. The markup language may be modified to include a resource identifier for the unique optical element corresponding to the access entity accessing the webpage. A resource identifier generally includes one or more unique identifiers used to specify an address of a resource, such as a unique optical element. A resource identifier enables retrieval of the resource from a network or a local system. It may encompass addresses like URLs (uniform resource locators) for resources on the internet, URIs (uniform resource identifiers) for more generalized identification across networks, or file paths for resources located on a local or directly connected memory.

For example, to modify the markup language of the webpage, webpage modifier 120 may insert or modify code that instructs a browser or other application to render the unique optical element when rendering the webpage from the markup language. In an aspect, the inserted or modified code includes a resource identifier to the stored unique optical element, such that the browser or other application retrieves the unique optical element and renders the webpage with the unique optical element according to the code. Various instructions can be included that cause the unique optical element to render as a background or superimposed object. Various instructions may be included that cause one or more copies of the unique optical element to render. In an aspect, the inserted or modified code causes the unique optical element to render with a repeating pattern, which may include a background repeating pattern, a repeating pattern that is superimposed over content of the webpages, or a combination thereof.

Client device 104 may render the webpage using the modified markup language. When doing so, the browser or other application executed by client device 104 interprets the markup language and renders the webpage accordingly. The browser or other application may access the unique optical element at the resource identifier included in the modified markup language and render the webpage with the unique optical element accordingly.

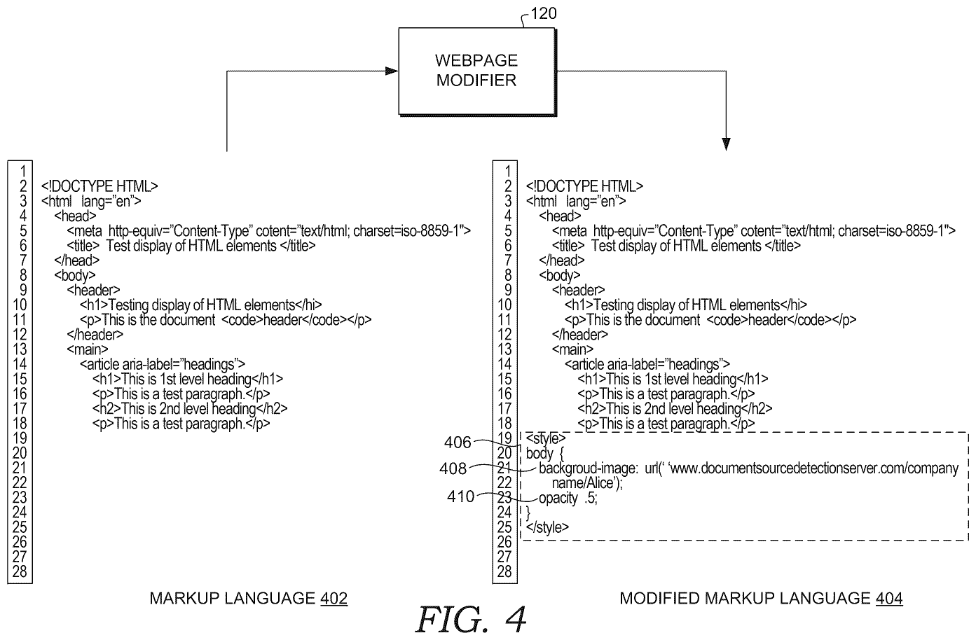

FIG. 4 illustrates an example depicting webpage modifier 120 modifying a markup language to generate modified markup language 404. In the illustrated example, markup language 402 can be used by a browser or other application to render a webpage. Webpage modifier 120 accesses markup language 402 and modifies (i.e., changes or inserts) code that causes the webpage to render with an identified unique optical element. In this example, webpage modifier 120 has inserted modification 406, which comprises code that causes a webpage to render with a unique optical element.

As noted, the unique optical element may be saved to memory and accessed using a resource identifier. Modification 406 made by webpage modifier 120 includes language 408 that can be used to access the unique optical element. In this case, the unique optical element can be accessed at a URL, which is included as part of language 408. Language may be added, which is not illustrated, to cause the unique optical element to render with one or more copies, and in some cases, with a repeating pattern that is provided as a background or superimposed over content, as discussed.

Further, in the example shown by FIG. 4, the opacity of the unique optical element rendered from modified markup language 404 is reduced. Here, opacity of the unique optical element has been reduced to 50% using language 410. Although shown as reduced to 50%, the opacity may be reduced to any degree to reduce obstruction of other content rendered using modified markup language 404.

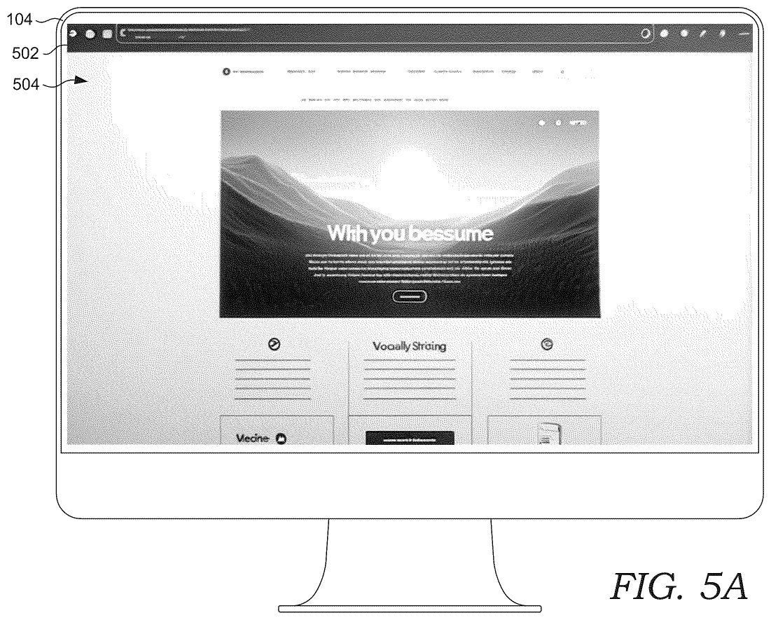

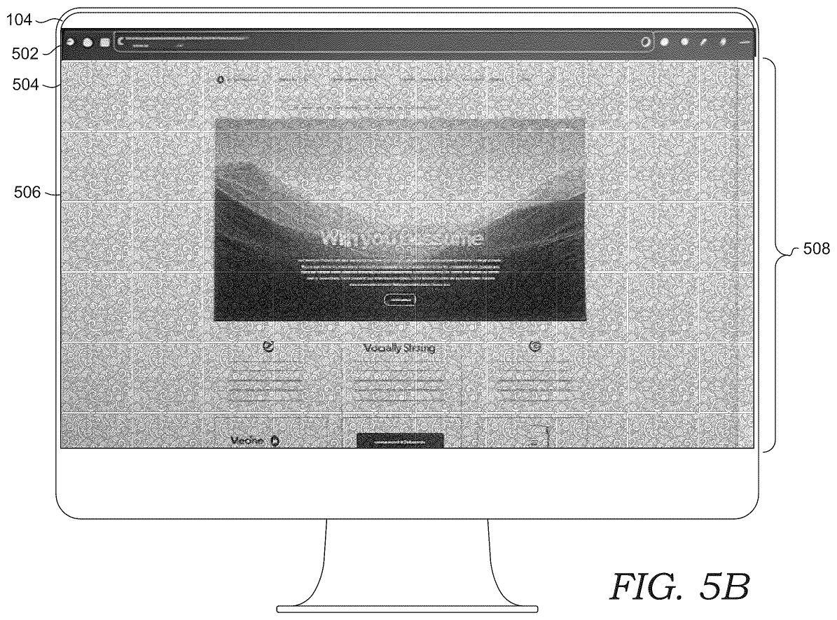

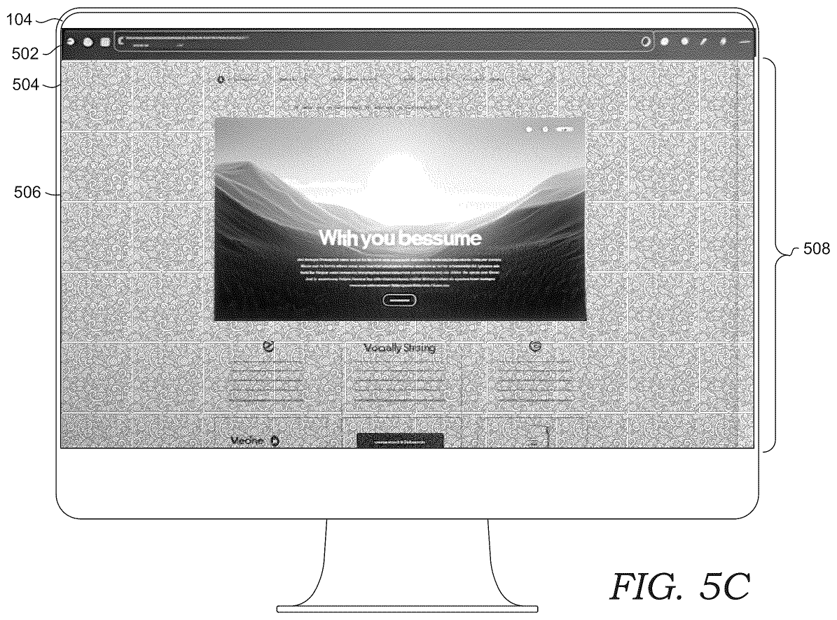

FIGS. 5A-5C illustrate an example webpage that may be rendered at client device 104. FIG. 5A depicts browser 502 rendering webpage 504. Webpage 504 may be rendered from a markup language. Webpage 504 comprises content, such as images and text.

FIG. 5B illustrates webpage 504 having been rendered from a modified markup language that causes unique optical element 506 to be rendered within webpage 504. As noted, one or more copies of unique optical element 506 may be rendered. Here, webpage 504 is rendered with a repeating pattern 508 of copies of unique optical element 506. In this particular example, repeating pattern 508 is superimposed over the content of webpage 504.

FIG. 5C illustrates another example of webpage 504 having been rendered from a modified markup language that causes unique optical element 506 to be rendered within webpage 504. In this example, webpage 504 is rendered with a repeating pattern 508 of copies of unique optical element 506, which has been rendered as background, e.g., the content of webpage 504 is superimposed over the repeating pattern 508.

Continuing with reference to FIG. 1, as noted, there may be webpages that include confidential information. This is often the case for many web-based application services, including those accessed via intranets and extranets. Medical records, banking and financial services, government systems, legal services, educational systems, and many others are all areas in which confidential information may be provided through web-based applications. Using the described methods, encoder 110 can cause webpages to render with a unique optical element that can help identify the access entity that accessed the webpage, which can be helpful in the event that there is a leak of information.

If a leak of information from a webpage does occur, often the leaked information is in a format that captures visual features of the webpages. This may occur if the webpage is printed, photographed, screen-captured, shared, snipped, or the like. The resulting captured object is referred to as an artifact of the webpage. Generally, an artifact can include any derivation of a webpage, in whole or in part. This can include digital derivations, such as digital photographs, digital copies, snapshots, screenshots, or other like derivations. Artifacts can include non-digital derivations, such as photographic prints, physical copies, printouts, and the like.

When an artifact is recovered, decoder 112 can be used to identify the access entity that accessed the webpage from which the artifact was derived. The example decoder 112 does so using unique optical element extractor 122 and access entity identifier 124.

In general, unique optical element extractor 122 may extract at least a portion of one or more unique optical elements within an artifact. In aspects, unique optical element extractor 122 isolates at least a portion of a unique optical element from an artifact.

Unique optical element extractor 122 may include a machine learning model that is trained to recognize objects, including unique optical elements. An example model includes a convolutional neural network (CNN). The model can be trained on a generated set of optical elements generated using the same methods as described with respect to encoded optical element generator 116 and nonencoded optical element generator 118. The generated optical elements can be used as a training set to train the model to recognize all or portions of unique optical elements within artifacts. Other models may be trained and used to identify unique optical elements within artifacts, and as such, the provided description is intended to be only an example of how the technology may be employed.

Unique optical element extractor 122 may employ the trained machine learning model to identify edges of a unique optical element, or portions thereof. In aspects, the unique optical element within the edges is extracted from the artifact, thereby isolating the unique optical element.

In aspects, unique optical element extractor 122 may identify more than one copy of a unique optical element within the artifact. This may be the case where multiple unique optical elements or a repeating pattern of copies of unique optical elements are captured within the artifact. If multiple copies of the unique optical element are identified, one of the unique optical elements may be isolated from the other copies. This may be done by removing an area outside the edges of one identified unique optical element. Where more than one unique optical element, i.e., unique optical elements having features distinct from one another, are identified, one of each unique optical element may be isolated from other respective copies.

In some cases, to assist with isolating a unique optical element, or portion thereof, unique optical element extractor 122 may employ the use of OCR engine 132 or object recognition model 134. OCR engine 132 may be applied to the artifact to identify text. Various OCR models suitable for identifying text and edges of characters of text, including both proprietary, open source, and custom models may be used. Having identified text within the artifact using OCR engine 132, the identified text may be removed when isolating the unique optical element. Object recognition model 134 may be applied to the artifact to identify an object, such as an image. The object may be content that is not part of the unique optical element. Various object recognition models suitable for identifying objects, including both proprietary, open source, and custom models may be used. Having identified an object within the artifact using object recognition model 134, the identified object may be removed when isolating the unique optical element. Aspects of the technology may optionally remove text or objects, or both, when isolating a unique optical element or portion thereof.

In aspects, unique optical element extractor 122 may apply one or more image editing techniques to enhance visibility of a unique optical element within an artifact. In an aspect, a contrast of the artifact is modified by unique optical element extractor 122. The contrast can be increased or decreased to enhance optical recognition of features within the unique optical element. That is, the contrast may be modified such that the unique optical element within the artifact having the modified contrast includes visual features that are more optically visible relative to the unique optical element within the artifact prior to modification of the contrast. Other techniques that may be applied by unique optical element extractor 122 include applying sharpening filters, performing high-pass filtering, frequency separation, edge detection filtering, and the like.

Decoder 112 may employ access entity identifier 124 to identify an access entity from a unique optical element, or a portion of a unique optical element, from within an artifact. In an aspect, access entity identifier 124 may identify an access entity directly from the unique optical element within the artifact. In an aspect, access entity identifier 124 identifies an access entity from at least a portion of a unique optical element that is extracted from the artifact using unique optical element extractor 122. In the example illustrated, access entity identifier 124 may employ encoded data extractor 126 to identify an access entity using encoded data extractor 126 or nonencoded optical element determiner 128.

In general, encoded data extractor 126 extracts encoded information from an encoded optical element in an artifact. As noted, encoded data extractor 126 may extract encoded information directly from an encoded optical element of the artifact or an encoded optical element isolated from the artifact using unique optical element extractor 122. The extracted information may be used by access entity identifier 124 to identify the access entity having accessed the webpage from which the artifact was derived.

In an aspect, encoded data extractor 126 receives a captured image comprising at least a portion of an encoded optical element. The captured images may be captured from the artifact using a camera, scanner, or the like, or may be otherwise accessed from a data file, e.g., one comprising an isolated encoded optical element. Encoded data extractor 126 may include an optical code reader that is configured to convert the image of the optical code into another format, such as a human-readable or machine-readable format. For standard types of encoded optical elements, such as QR codes, standard optical code readers are obtainable. These readers can extract encoded information from the encoded optical elements. In general, the optical reader uses the encoding scheme that encoded the data into the encoded optical element to extract and provide the encoded data.

As previously discussed, the data encoded within an encoded optical element may include access entity identifying information. This may include a data string. Access entity identifier 124 can use the unique string to identify and provide the access entity using source index 130.

In aspects where the artifact includes a nonencoded optical element, nonencoded optical element determiner 128 may be employed by access entity identifier 124 to identify an access entity. Nonencoded optical element determiner 128 may use at least a portion of a unique optical element isolated by unique optical element extractor 122 to identify the access entity having accessed the webpage from which the artifact was derived.

In aspects, nonencoded optical element determiner 128 compares at least a portion of a nonencoded optical element from an artifact to stored nonencoded optical elements that correspond to access entities. For instance, the stored nonencoded optical elements may have been generated by nonencoded optical element generator 118. The stored nonencoded optical elements may be accessed via source index 130. Based on the comparison, nonencoded optical element determiner 128 identifies a nonencoded optical element that has a greater number of features in common (those features that are included in both nonencoded optical elements) with the nonencoded optical element of the artifact relative to features in common with other nonencoded optical elements stored in source index 130. Access entity identifier 124 may identify the access entity that corresponds to the stored nonencoded optical element that has the most features in common with the nonencoded optical element of the artifact as the access entity that accessed the webpages from which the artifact was derived.

As an example, a comparison method identifies and uses keypoints between the nonencoded optical element from the artifact and the known stored nonencoded optical elements corresponding to the access entities. Keypoints includes pixels areas within a nonencoded optical element that have an identifiable feature. For instance, this could include edges, where adjacent pixels have different colors or intensities. Other pixel areas identified may include corners or curves, such as those pixel areas having traceable edges taking a geographic shape. These are just examples, and other identifiable features within the pixels may be considered keypoints.

To identify keypoints, a keypoint identification model may be trained and employed by nonencoded optical element determiner 128. For instance, a machine learning model, such as a CNN, may be trained on a labeled dataset that includes images tagged to indicate identifiable features, such as corners, edges, or other pixel features. Responsive to the training, the keypoint identification model identifies one or more keypoints from an input image.

Nonencoded optical element determiner 128 can use the trained keypoint identification model to identify keypoints in the nonencoded optical element from the artifact and identify keypoints in the known stored nonencoded optical elements corresponding to the access entities.

Each of the stored nonencoded optical elements may be compared to the nonencoded optical element from the artifact using the keypoints. During the comparison, keypoints in the nonencoded optical element from the artifact can be matched to keypoints within a nonencoded optical element corresponding to an access entity. For instance, the keypoints, including a pixel region surrounding the identified keypoints, can be represented as vectors in the vector space. The vectors can be compared based on their distance to determine whether a keypoint within the nonencoded optical element of the artifact matches a keypoint within the stored nonencoded optical element corresponding to the access entity.

In aspects, rigid transformation techniques may also be used to aid in comparing and matching the keypoints. The rigid transformation restricts the matching of the keypoints along certain rotations, translations, reflections, or any sequence of these.

At least a portion of the stored nonencoded optical elements can be ranked based on the matching keypoints. For instance, the stored nonencoded optical elements may be ranked based on the number of matching keypoints. In aspects, the stored nonencoded optical elements may be ranked based on the overall fit between matching keypoints (e.g., how closely the matching keypoints match). Based on the ranking, the top-ranked stored nonencoded optical element may be determined by nonencoded optical element determiner 128 to match the nonencoded optical element from the artifact. In aspects, one or more statistical analysis measures may be employed to determine the strength of certainty of the match. Access entity identifier 124 identifies the access entity that corresponds to the stored nonencoded optical element determined to match the nonencoded optical element of the artifact using nonencoded optical element determiner 128.

Some example methods for identifying and matching keypoints is described in U.S. patent application Ser. No. 18/179,635, filed on Mar. 7, 2023, entitled “Information Source Detection Using Unique Watermarks,” which is expressly incorporated herein by reference in its entirety.

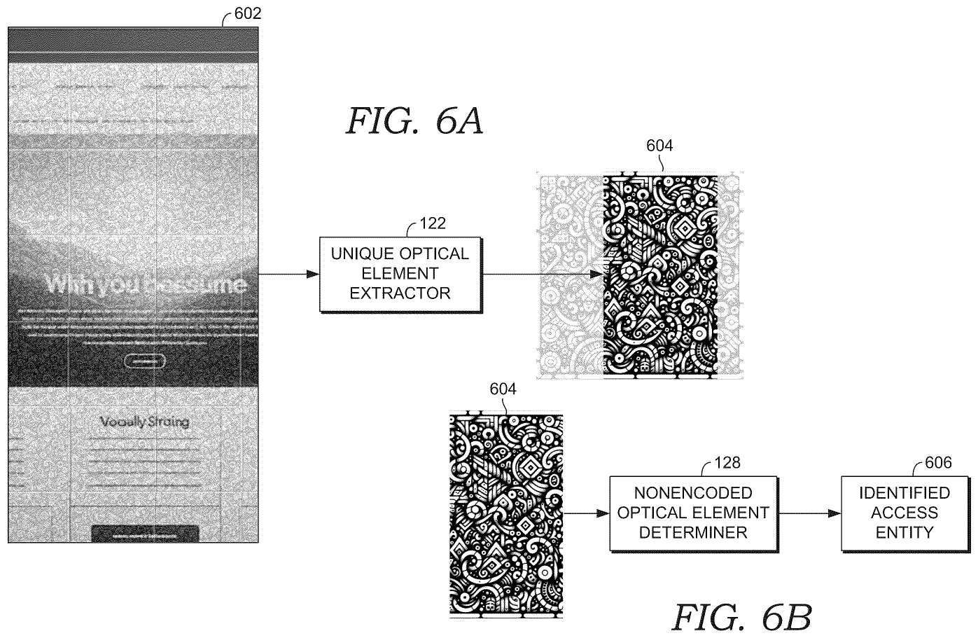

FIGS. 6A and 6B illustrate example aspects in which access entity identifier 124 can be used to identify an access entity from an artifact. In FIG. 6A, artifact 602 has been derived from a webpage. In this example, unique optical element extractor 122 is used to extract at least a portion (all or portion of) a nonencoded optical element included within artifact 602, illustrated as extracted nonencoded optical element 604. Nonencoded optical element determiner 128 can match extracted nonencoded optical element 604 to a stored nonencoded optical element, from which access entity identifier 124 can identify identified access entity 606.

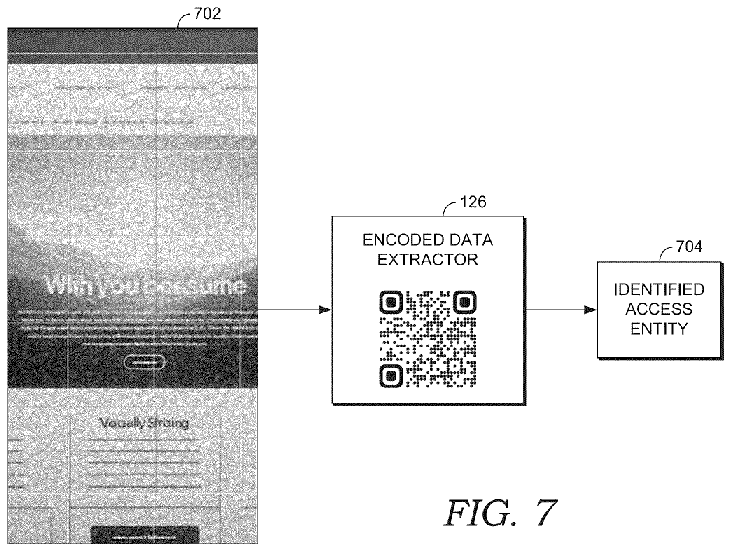

FIG. 7 illustrates another example in which an access entity is identified from at least a portion of a unique optical element. In this aspect, artifact 702 includes at least a portion of a unique optical element that is an encoded optical element. The encoded optical element can be read using encoded data extractor 126 to decode the identifying information, from which access entity identifier 124 can identity identified access entity 704.

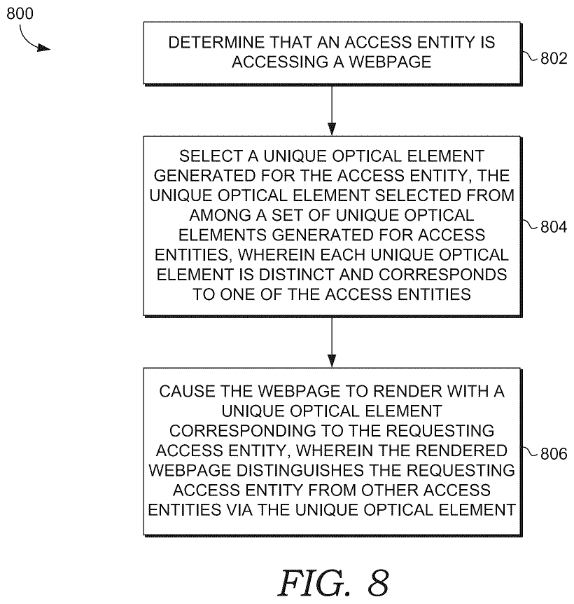

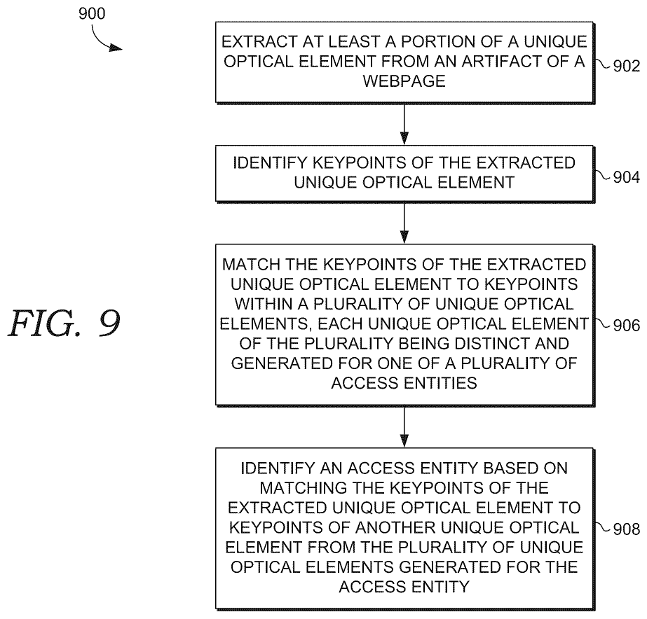

With reference now to FIGS. 8-9, block diagrams are provided respectively illustrating methods 800 and 900 for rendering webpages and identifying access entities using unique optical elements. Each block of methods 800 and 900 may comprise a computing process performed using any combination of hardware, firmware, or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few possibilities.

With specific reference to FIG. 8, a method 800 is provided for causing a webpage to render with a unique optical element that identifies an access entity. Method 800 may be performed using encoder 110.

In block 802, method 800 determines that an access entity is accessing a webpage. The access entity may be included as part of a plurality of access entities for which unique optical elements have been generated. An aspect of the method includes generating the unique optical elements for the plurality of entities, such as those having access to the webpage. Each of the unique optical elements may be distinct, having at least one feature that is different from other unique optical elements. Unique optical elements may include encoded optical elements or nonencoded optical elements. Encoded and nonencoded optical elements may be generated using unique optical element generator 114.

In aspects, generating encoded optical elements as the unique optical elements may include generating a unique string for each of the access entities. The unique string can include information usable to identify an access entity. The unique string can be encoded into the encoded optical elements. In aspects, nonencoded optical elements are generated, and each nonencoded optical element has a visually different appearance.

In block 804, method 800 selects a unique optical element generated for the access entity. The unique optical element may be selected from among a set of unique optical elements generated for access entities. The set of unique optical elements may include all or a portion of the unique optical elements generated for the plurality of access entities. The unique optical element may be selected based on the unique optical element corresponding to the identified access entity.

In block 806, method 800 causes the webpage to render with the unique optical element corresponding to the access entity that is requesting access to the webpage. As such, the rendered webpage distinguishes the access entity from other access entities via the unique optical element. Webpage modifier 120 may be used to select the unique optical element and cause the webpage to render with it. Webpage modifier 120 may cause the webpage to render with the unique optical element by modifying a markup language used to render the webpage, such that the markup language includes a resource identifier for the unique optical element corresponding to the access entity. The webpage may be rendered by a browser or other application using the modified markup language.

In an aspect, the webpage renders with the unique optical element having an opacity that is less than an opacity of content included on the rendered webpage. This may be done by modifying the markup language that renders the webpage to reduce the opacity of the unique optical element relative to other content of the webpage. Webpage modifier 120 may be used to modify the markup language to adjust the relative opacity.

In an aspect, the webpage renders with a repeating pattern of the unique optical element. The repeating pattern comprises a plurality of copies of the unique optical element. Each copy of the unique optical element may be adjacent to another copy of the unique optical element within the pattern. Webpage modifier 120 may be used to modify the markup language so that the unique optical element renders as a repeating pattern of copies of the unique optical element.

Turning now to FIG. 9, an example method 900 is provided for identifying an access entity from an artifact of a webpage. Method 900 may be performed by decoder 112.

In block 902, method 900 extracts at least a portion of a unique optical element from an artifact of a webpage. This may be done using encoded data extractor 126. In an aspect, the unique optical element is a nonencoded optical element. Unique optical element extractor 122 may be used to extract a unique optical element (i.e., at least the portion of the unique optical element).

In an aspect, the unique optical element is extracted from an artifact having a repeating pattern of copies of the unique optical element. For instance, the unique optical element of the artifact may be isolated from among other copies of the unique optical element within the repeating pattern to extract the unique optical element. This may be performed using unique optical element extractor 122.

In aspects, method 900 may include performing an OCR process that identifies text within the artifact. The text may be removed to further isolate the unique optical element from the artifact for extraction. This may be performed by unique optical element extractor 122.

In aspects, method 900 may include performing an object recognition process that identifies an object, such as an image, within an artifact. The object may be removed to further isolate the unique optical element from the artifact for extraction. This may be performed by unique optical element extractor 122.

In aspects, unique optical element extractor 122 may modify a contrast of the artifact to enhance optical recognition of features of the unique optical element from the artifact. The portion of the unique optical element can be extracted from the artifact with the modified contrast.

In block 904, method 900 identifies keypoints of the extracted unique optical element. In block 906, method 900 matches the keypoints of the extracted unique optical element to keypoints within a plurality of unique optical elements. Each unique optical element of the plurality may be distinct and generated for one of a plurality of access entities. The keypoints may be identified and matched using nonencoded optical element determiner 128.

To match keypoints, nonencoded optical element determiner 128 may determine a pixel neighborhood for each of the keypoints of the extracted unique optical element and a pixel neighborhood for each of the keypoints within the plurality of unique optical elements. A vector for each of the pixel neighborhoods for the keypoints of the extracted unique optical element and the keypoints within the plurality of unique optical elements can be determined. The vectors corresponding to the extracted unique optical element can be compared with the vectors corresponding to the plurality of unique optical elements to select the unique optical element from the plurality of unique optical elements for identifying the access entity.

In block 908, method 900 identifies an access entity based on matching the keypoints of the extracted unique optical element to keypoints of another unique optical element from the plurality of unique optical elements generated for the access entity. The access entity may be identified using access entity identifier 124.

Having described an overview of some embodiments of the present technology, an example computing environment in which embodiments of the present technology may be implemented is described below in order to provide a general context for various aspects of the present technology. Referring now to FIG. 10 in particular, an example operating environment for implementing embodiments of the present technology is shown and designated generally as computing device 1000. Computing device 1000 is but one example of a suitable computing environment and is not intended to suggest any limitation as to the scope of use or functionality of the technology. Computing device 1000 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 10, computing device 1000 includes bus 1002, which directly or indirectly couples the following devices: memory 1004, one or more processors 1006, one or more presentation components 1008, input/output (I/O) ports 1010, input/output components 1012, and illustrative power supply 1014. Bus 1502 represents what may be one or more buses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 10 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 10 and with reference to “computing device.”

Computing device 1000 typically includes a variety of computer-readable media. Computer-readable media can be any available media that can be accessed by computing device 1000 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 1000. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1004 includes computer storage media in the form of volatile or non-volatile memory. The memory may be removable, non-removable, or a combination thereof. Example hardware devices include solid-state memory, hard drives, optical-disc drives, etc. Computing device 1000 includes one or more processors that read data from various entities, such as memory 1004 or I/O components 1012. Presentation component(s) 1008 presents data indications to a user or other device. Example presentation components include a display device, speaker, printing component, vibrating component, etc.

I/O ports 1010 allow computing device 1000 to be logically coupled to other devices, including I/O components 1012, some of which may be built-in. Illustrative components include a microphone, joystick, game pad, satellite dish, scanner, printer, wireless device, etc. The I/O components 1012 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 1000. Computing device 1000 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 1000 may be equipped with accelerometers or gyroscopes that enable detection of motion. The output of the accelerometers or gyroscopes may be provided to the display of computing device 1000 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. Any other variations and combinations thereof are contemplated within embodiments of the present technology.

With reference back to FIG. 1, as with other components of FIG. 1, server 102 and client device 104 are each intended to represent one or more devices. In implementations, client device 104 is a client-side or front-end device, and server 102 represents a back-end or server-side device. It will be understood that some implementations of the technology will comprise either a client-side or front-end computing device, a back-end or server-side computing device, or both, executing any combination of functions for generating or rendering unique optical elements within a webpage. FIG. 1 is simply one example illustration of a computing environment in which the technology may be employed, although it will be recognized that other arrangements of devices and functions may be used with the technology as well. All are intended to be within the scope of the present disclosure, as will be further noted.

Database 106 generally stores information, including data, computer instructions (e.g., software program instructions, routines, or services), or models used in embodiments of the described technologies. Although depicted as a single database component, database 106 may be embodied as one or more databases or may be in the cloud.

Network 108 may include one or more networks (e.g., public network or virtual private network [VPN]), as shown with network 108. Network 108 may include, without limitation, one or more local area networks (LANs), wide area networks (WANs), or any other communication network or method.

It is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to encoder 110 and decoder 112, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of encoder 110 and decoder 112, among other functions, may be performed by server 102, client device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the words “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example aspects that can be practiced from the foregoing description include the following:

Aspect 1: A computer implemented method comprising: generating unique optical elements for access entities having access to a webpage, each unique optical element being distinct and corresponding to one of the access entities; determining that an access entity is requesting access to the webpage; and causing the webpage to render with a unique optical element corresponding to the requesting access entity, wherein the rendered webpage distinguishes the requesting access entity from other access entities via the unique optical element.

Aspect 2: One or more computer storage media storing computer-readable instructions thereon that, when executed by a processor, cause the processor to perform operations comprising: determining that an access entity is accessing a webpage; selecting a unique optical element generated for the access entity, the unique optical element selected from among a set of unique optical elements generated for access entities, wherein each unique optical element is distinct and corresponds to one of the access entities; and causing the webpage to render with the unique optical element corresponding to the access entity, wherein the rendered webpage distinguishes the access entity from other access entities via the unique optical element.

Aspect 3: Any of Aspects 1-2, further comprising: generating a unique string for each of the access entities; and encoding the unique strings into encoded optical elements to generate the unique optical elements, wherein the unique optical element corresponding to the requesting access entity comprises an encoded optical element that identifies the requesting access entity.

Aspect 4: Any of Aspects 1-2, further generating nonencoded optical elements as the unique optical elements for the access entities, each nonencoded optical element having a visually different appearance.

Aspect 5: Any of Aspects 1-4, further comprising modifying a markup language used to render the webpage, such that the markup language includes a resource identifier for the unique optical element corresponding to the access entity.

Aspect 6: Any of Aspects 1-5, wherein the webpage renders with the unique optical element having an opacity that is less than an opacity of content included on the rendered webpage.

Aspect 7: Any of Aspects 1-6, wherein the webpage renders with a repeating pattern of the unique optical element.

Aspect 8: A system comprising: at least one processor; and one or more computer storage media storing computer-readable instructions thereon that, when executed by the at least one processor, cause the at least one processor to perform operations comprising: extracting at least a portion of a unique optical element from an artifact of a webpage; identifying keypoints of the extracted unique optical element; matching the keypoints of the extracted unique optical element to keypoints within a plurality of unique optical elements, each unique optical element of the plurality being distinct and generated for one of a plurality of access entities; and identifying an access entity based on matching the keypoints of the extracted unique optical element to keypoints of a unique optical element from the plurality of unique optical elements generated for the access entity.

Aspect 9: Aspect 8, further comprising: performing an optical character recognition process to identify text within the artifact; and removing the identified text to isolate the portion of the unique optical element from the artifact.

Aspect 10: Any of Aspects 8-9, further comprising: performing an object recognition process to identify an object within the artifact; and removing the identified object to isolate the portion of the unique optical element from the artifact.

Aspect 11: Any of Aspects 8-10, wherein the plurality of unique optical elements comprises nonencoded optical elements, each nonencoded optical element having a visually different appearance.

Aspect 12: Any of Aspects 8-11, wherein the portion of the unique optical element is extracted from a repeating pattern of the unique optical element within the artifact.

Aspect 13: Aspect 12, further comprising isolating the unique optical element of the artifact from among other copies of the unique optical element within the repeating pattern.

Aspect 14: Any of Aspects 8-13, further comprising modifying a contrast of the artifact to enhance optical recognition of features of the unique optical element from the artifact, wherein the portion of the unique optical element from the artifact is extracted from the artifact with the modified contrast.

Aspect 15: Any of Aspects 8-14, further comprising: determining a pixel neighborhood for each of the keypoints of the extracted unique optical element and a pixel neighborhood for each of the keypoints within the plurality of unique optical elements; determining a vector for each of the pixel neighborhoods for the keypoints of the extracted unique optical element and the keypoints within the plurality of unique optical elements; and comparing the vectors corresponding to the extracted unique optical element with the vectors corresponding to the plurality of unique optical elements to select the unique optical element from the plurality of unique optical elements.

What is claimed is:

1. A computer implemented method comprising:
generating unique optical elements for access entities having access to a webpage, each unique optical element being distinct and corresponding to one of the access entities;
determining that an access entity is requesting access to the webpage; and
causing the webpage to render with a unique optical element corresponding to the requesting access entity, wherein the rendered webpage distinguishes the requesting access entity from other access entities via the unique optical element.

2. The computer implemented method of claim 1, further comprising:
generating a unique string for each of the access entities; and
encoding the unique strings into encoded optical elements to generate the unique optical elements, wherein the unique optical element corresponding to the requesting access entity comprises an encoded optical element that identifies the requesting access entity.

3. The computer implemented method of claim 1, further generating nonencoded optical elements as the unique optical elements for the access entities, each nonencoded optical element having a visually different appearance.

4. The computer implemented method of claim 1, further comprising modifying a markup language used to render the webpage, such that the markup language includes a resource identifier for the unique optical element corresponding to the access entity.

5. The computer implemented method of claim 1, wherein the webpage renders with the unique optical element having an opacity that is less than an opacity of content included on the rendered webpage.

6. The computer implemented method of claim 1, wherein the webpage renders with a repeating pattern of the unique optical element.

7. One or more computer storage media storing computer-readable instructions thereon that, when executed by a processor, cause the processor to perform operations comprising:
determining that an access entity is accessing a webpage;
selecting a unique optical element generated for the access entity, the unique optical element selected from among a set of unique optical elements generated for access entities, wherein each unique optical element is distinct and corresponds to one of the access entities; and
causing the webpage to render with the unique optical element corresponding to the access entity, wherein the rendered webpage distinguishes the access entity from other access entities via the unique optical element.

8. The media of claim 7, wherein the unique optical element comprises an encoded optical element that encodes a unique string identifying the access entity.

9. The media of claim 7, wherein the set of unique optical elements comprises nonencoded optical elements, each nonencoded optical element having a visually different appearance.

10. The media of claim 7, further comprising modifying a markup language used to render the webpage, such that the markup language includes a resource identifier for the unique optical element corresponding to the access entity.

11. The media of claim 7, wherein the webpage renders with the unique optical element having an opacity that is less than an opacity of content included on the rendered webpage.

12. The media of claim 7, wherein the webpage renders with a repeating pattern of the unique optical element.

13. A system comprising:
at least one processor; and
one or more computer storage media storing computer-readable instructions thereon that, when executed by the at least one processor, cause the at least one processor to perform operations comprising:
extracting at least a portion of a unique optical element from an artifact of a webpage;
identifying keypoints of the extracted unique optical element;
matching the keypoints of the extracted unique optical element to keypoints within a plurality of unique optical elements, each unique optical element of the plurality being distinct and generated for one of a plurality of access entities; and
identifying an access entity based on matching the keypoints of the extracted unique optical element to keypoints of a unique optical element from the plurality of unique optical elements generated for the access entity.

14. The system of claim 13, further comprising:
performing an optical character recognition process to identify text within the artifact; and
removing the identified text to isolate the portion of the unique optical element from the artifact.

15. The system of claim 13, further comprising:
performing an object recognition process to identify an object within the artifact; and
removing the identified object to isolate the portion of the unique optical element from the artifact.

16. The system of claim 13, wherein the plurality of unique optical elements comprises nonencoded optical elements, each nonencoded optical element having a visually different appearance.

17. The system of claim 13, wherein the portion of the unique optical element is extracted from a repeating pattern of the unique optical element within the artifact.

18. The system of claim 17, further comprising isolating the unique optical element of the artifact from among other copies of the unique optical element within the repeating pattern.

19. The system of claim 13, further comprising modifying a contrast of the artifact to enhance optical recognition of features of the unique optical element from the artifact, wherein the portion of the unique optical element from the artifact is extracted from the artifact with the modified contrast.

20. The system of claim 13, further comprising:
determining a pixel neighborhood for each of the keypoints of the extracted unique optical element and a pixel neighborhood for each of the keypoints within the plurality of unique optical elements;
determining a vector for each of the pixel neighborhoods for the keypoints of the extracted unique optical element and the keypoints within the plurality of unique optical elements; and
comparing the vectors corresponding to the extracted unique optical element with the vectors corresponding to the plurality of unique optical elements to select the unique optical element from the plurality of unique optical elements.
